(19) United States
(12) Patent Application Publication
(10) Pub. No.: US 2002/0100048 A1
(43) Pub. Date: Jul. 25, 2002

(54) Upcoming program information display

(76) Inventors: Hong Yang, San Diego, CA (US); Jenny Su Chow, San Diego, CA (US); Padmarabhan Sundararajan, San Diego, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/770,995

(22) Filed: Jan. 25, 2001

Related U.S. Application Data
(60) Provisional application No. 60/215,291, filed on Jun. 30, 2000.

(51) Int. Cl. G06F 3/00; H04N 5/445; G06F 13/00; H04N 7/20

(52) U.S. Cl. 725/47; 725/40; 725/68

(57) ABSTRACT

A methods for displaying upcoming program information in a broadcasting system. According to one embodiment, a display options menu is generated. The display options menu contains several selectable display options including an upcoming program display option. The upcoming program display option further contains an ON and an OFF option for allowing a user to select and display information relating to an upcoming program on a channel. A display of an upcoming program is generated by selecting the upcoming display ON option. The display includes a title, starting and ending time of the upcoming program.

### FIELD OF THE INVENTION

The present invention relates to presentation of upcoming broadcast information in a multiple channel broadcast system.

### INTRODUCTION AND BACKGROUND OF THE INVENTION

Television broadcasting technology has improved tremendously since its inception. Today, television signals are broadcasted on the airwaves, through cables, and via satellite. The number of stations accessible today has increased to hundreds of stations. To select a program to view, many viewers simply “channel surf” until they find a channel that has a desirable program. Channel surfing refers to the process of using the channel “+” or “−” key to sequentially view each channel. Although some viewers find channel surfing among hundreds of stations enjoyable, most viewers prefer a more direct method for selecting a program to view.

Some prior art television channel selection guides provide a television channel selection guide which displays a listing of the channels typically in numeric order and the titles of the programs broadcasted or to be broadcasted on the channels. The viewer or user of the system may then select the channel by entering in the channel number or selecting a program. The system responds by removing the guide displayed and tuning to the station selected and displaying the broadcast signals of the station.

A viewer is provided with many options regarding programs that are available for broadcast. These options include, but are not limited to, channel surfing among program descriptions while watching a particular program on one channel, on-demand selection of pay-per-view broadcasts, selection of a broadcast for automatic recording, and programming a broadcast system to tune to a preselected station at a designated time. These options are typically accessed through graphical user interfaces. As the number of viewer options increases, so to does the need for a user-friendly system interface. The prior art channel selection guides do not provide ready indications as to the functional areas of the system interface. In addition, as the channel selection guides become more interactive and provide the viewer with more selections, the lack of distinguishing features of interactive portions of the displays can lead to a great deal of viewer frustration.

### SUMMARY OF THE INVENTION

The present invention provides several methods and apparatuses for displaying upcoming program information in a broadcasting system. According to one embodiment, a display options menu is generated. The display options menu contains several selectable display options including an upcoming display option. The upcoming display option further contains an ON and an OFF option for allowing a user to select and display information relating to an upcoming program on a channel. A display of an upcoming program is generated by selecting the upcoming program display ON option. The display includes a title, starting and ending time of the upcoming program.

### BRIEF DESCRIPTION OF THE DRAWINGS

The objects, features, and advantages of the present invention will be apparent to one skilled in the art from the following detailed description in which:

FIG. 1A is a simple illustration of one embodiment of the present invention.

FIG. 1B is a simple illustration of one embodiment of the present invention.

FIG. 2 illustrates an exemplary block diagram representation of elements utilized in receiving television signals, which may be used in accordance with one embodiment of the present invention.

FIG. 3 illustrates one exemplary type of data utilized to present the electronic program guide, which may be used in accordance with one embodiment of the present invention.

FIG. 4 illustrates one embodiment of pointers to the data utilized for generating an electronic program guide, which may be used in accordance with one embodiment of the present invention.

FIG. 5 illustrates one exemplary process flow diagram for displaying an upcoming program information display.

FIG. 6 illustrates one embodiment of a display options menu showing various types of display options.

FIG. 7 illustrates one embodiment of an Upcoming program information feature ON/OFF option within the display options menu.

FIG. 8 illustrates one exemplary process flow diagram for using the Upcoming program information feature.

FIG. 9 illustrates one embodiment of an Upcoming program information feature display showing an upcoming program title, and start and end times.

FIG. 10 illustrates examples of upcoming program information displayed by one embodiment of the Upcoming program information feature.

### DETAILED DESCRIPTION

In the method and apparatus of the present invention the broadcast system described is a direct broadcast satellite system. However, it is readily apparent to one skilled in the art that other broadcast systems and devices which have the capability of receiving and displaying, in a realtime or a time-delay manner, a multiplicity of channels on stations may utilize the method and apparatus of the present invention. Furthermore, in the following description, for purposes of explanation, numerous details are set forth, such as menus, guides, flowcharts, and system configurations, in order to provide a thorough understanding of the present invention. However, it will be apparent to one skilled in the art that these specific details are not required in order to practice the present invention. In other instances, well-known electrical structures and circuits are shown in block diagram form in order not to necessarily obscure the present invention.

It is readily apparent to one skilled in the art that additional functions can be added to the process and functions modified or removed and still be within the spirit and scope of the invention. The system provides an innovative and user friendly access to information regarding programming available through the broadcasting system.

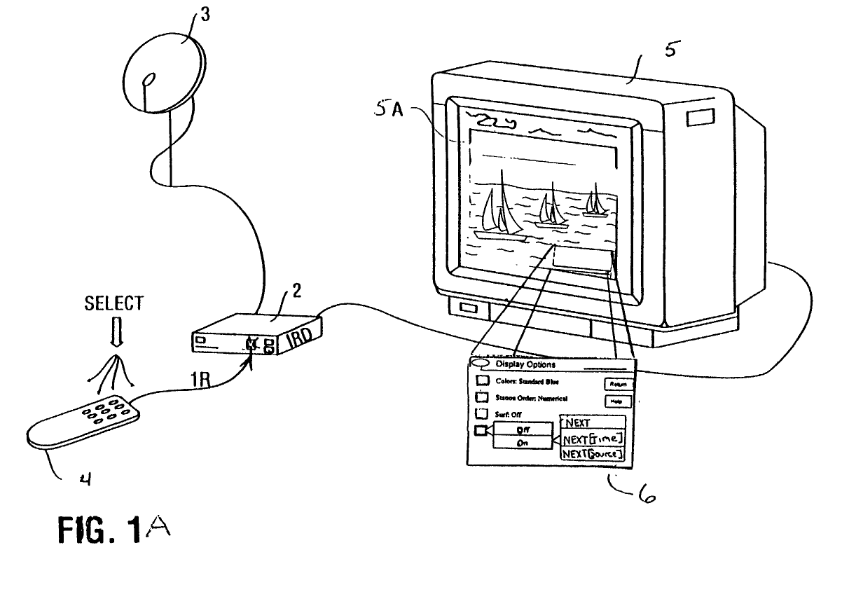

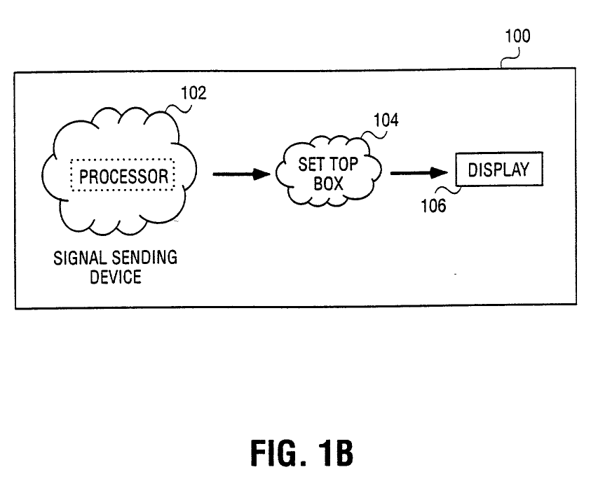

FIG. 1A is a simplified diagram illustrating an embodiment of a Direct Satellite System (DSS) for use with the present invention. The system has an antenna 3, an integrated receiver/decoder IRD2, a remote controller 4, and a display monitor 5 having a display screen 5A. The display monitor 5 is currently displaying, on its display screen 5A, a display options menu 6 that has the Upcoming program information feature selected in accordance with the present invention.

The antenna 3 receives an encoded data signal sent from a satellite. The received encoded signal is decoded by the IRD2. The antenna 3 has a low noise block down converter 3a (LNB) not shown in FIG. 1. The LNB 3a converts a frequency of a signal sent from the satellite to another frequency. The converted signal is supplied to the IRD2. The monitor 4 receives a signal from the IRD2.

A simplified block diagram of one embodiment of the system of the present invention is illustrated in FIG. 1B. The present embodiment illustrates a system 100 which includes a set top box controller 104, which controls a television display 106. It is readily apparent that the system is not limited to set top boxes and televisions; rather, the system also can be embodied in other types of processor-based systems including computing systems that control displays, and recording and time delay playback systems.

Referring to FIG. 1B, the system 100 includes a set top box controller 104, a signal sending device 102, and a display device 106. The set top box controller 104 controls the display of information such as broadcasts received from satellite transmissions and associated data. In addition, the controller 104 preferably includes a receiving function that operates to receive input from a signal-sending device in accordance with the teachings of the present invention. In one embodiment, a separate logic or processor may implement the signal-sending device 102.

The incoming signal data from the signal-sending device 102 may include data, such as, electronic programming guide data, as well as user preferences, and including indications when a viewer expresses interest in viewing a particular program folder or category. The set top box controller 104 can be configured to include a variety of functions known to those skilled in the art in addition to those functions described herein. Furthermore, in accordance with the teachings of the present invention, the controller 104 can be configured to store selections made by a user into its memory for allowing a user to navigate back and forth from previously made selections

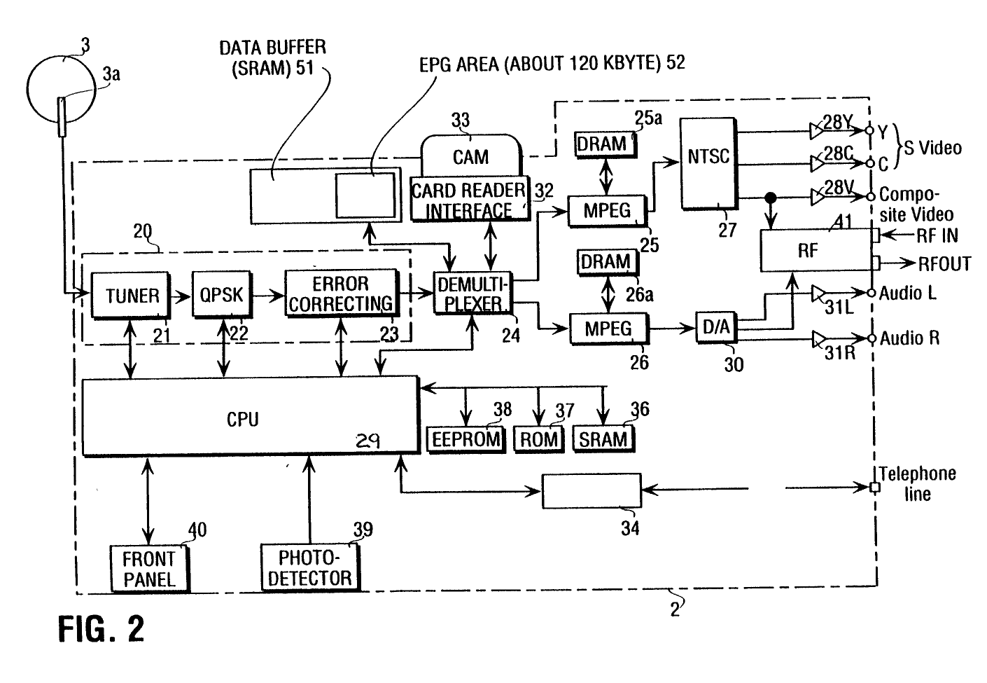

FIG. 2 is a block diagram of one embodiment of the IRD 2. A radio frequency (RF) signal output from the antenna 3 is supplied to a tuner 21 of a front end 20. The output from the tuner 21 is supplied to a quadrature phase shift keying (QPSK) demodulation circuit 22 for demodulation. The output from the QPSK demodulation circuit 22 is supplied to an error correcting circuit 23 for error correction. The data is received in encrypted and encoded (i.e., compressed) form.

The transport IC 24 receives the data stream, consisting of packets of data, from the error correcting circuit 23 and directs portions of the data stream to the appropriate circuit for processing. The digital data stream sent from a satellite includes headers for classifying the different portions of the data in the digital data stream. The transport IC stores the headers in registers and uses the headers to direct the data. In the embodiment described herein, the data stream sent from the satellite includes video data in the format specified by the Motion Pictures Expert Group standard (MPEG), MPEG audio data and electronic programming guide (EPG) data. Data that is identified by its header to be video data is transferred to MPEG video decoder 25. Data that is identified by its header to be audio data is transferred to MPEG audio decoder 26. Similarly, data having a header that identifies the data to be EPG data is transferred to a predetermined area 52 in the data buffer 51 designated to store the EPG.

A conditional access module 33, includes a central processing unit (CPU), a read-only memory (ROM) and a random access memory (RAM). The conditional access module determines whether the user has the authorization to receive certain data, e.g., audio/video for a pay TV station, using the authorization information stored in its memory. Thus, if the conditional access module determines that the user is authorized access, a key to decrypt the incoming data is provided to the transport IC 24, which decrypts the data using the key provided. In one embodiment, a smart card is utilized. This card is inserted into the card reader interface 32 for interface to the transport IC 24. It is readily apparent to one skilled in the art that the conditional access module is not limited to smart cards and may be configured in other kinds of circuitry.

The MPEG video decoder 25 decodes the video signal received from the transport IC. Dynamic random access memory (DRAM) 25a, connected to the MPEG video decoder 25, is used for buffering and storage of video data during processing by the MPEG video decoder. The decoded digital video signal is supplied to a National Television System Committee (NTSC) encoder 27 and converted to a luminance signal (Y) and a chroma signal (C) which are respectively output through a buffer amplifier 28Y or 28C as an S video signal. A composite video signal is also output through a buffer amplifier 28V.

The MPEG audio decoder 26 decodes the digital audio signal. DRAM 26a, connected to the MPEG audio decoder 26, is used for buffering of data and information during processing by the MPEG audio decoder 26. The decoded digital audio signal is converted into an analog audio signal by D/A converter 30. The left audio signal is output through buffer amplifier 31L and the right audio signal is output through buffer amplifier 31R.

An RF modulator 41 mixes a composite signal output from the NTSC encoder 27 with an analog audio signal output from the D/A converter 30. The RF modulator 41 converts the mixed signal into an RF signal and outputs the RF signal therefrom.

The CPU 29 is the central control mechanism and executes instructions code stored in memory, for example ROM 37, to perform certain functions of the system. For example, the CPU 29 processes certain data to control the generation of the folders and resultant program list in accordance with the teachings of the present invention. In addition, the CPU 29 receives and processes the user input, received from the front panel buttons or switches 40 and the photo detector circuit 39 to provide the user functionality and access to the system described herein. In addition, the CPU 29 accesses user settings/preferences for processing of information and configuration of the system. The user settings are stored in the non-volatile memory, such as electrically erasable programmable read-only memory (EEPROM) 38. In addition, the CPU 29 accesses user settings/preferences for processing of information and configuration of the system. The user settings are stored in the non-volatile memory, such as electrically erasable programmable read-only memory (EEPROM) 38. In addition, the CPU 29 maintains a list of pointers, stored in static random access memory (SRAM) 36, to the channel information and program information stored in the SRAM 51. Thus, when a user wishes to display a form of the EPG on the screen, the CPU 29, accessing pointers stored in the SRAM 36, communicates to the transport IC 34 to retrieve the data from the data buffer (SRAM) 51 identified by the pointers. The CPU then formulates the format and other digital data which forms the guide or list on the screen and forwards the data representative of the guide/list to the transport IC 34 which forwards the data to the DRAM 25a of the MPEG video decoder 25 for subsequent output to the screen.

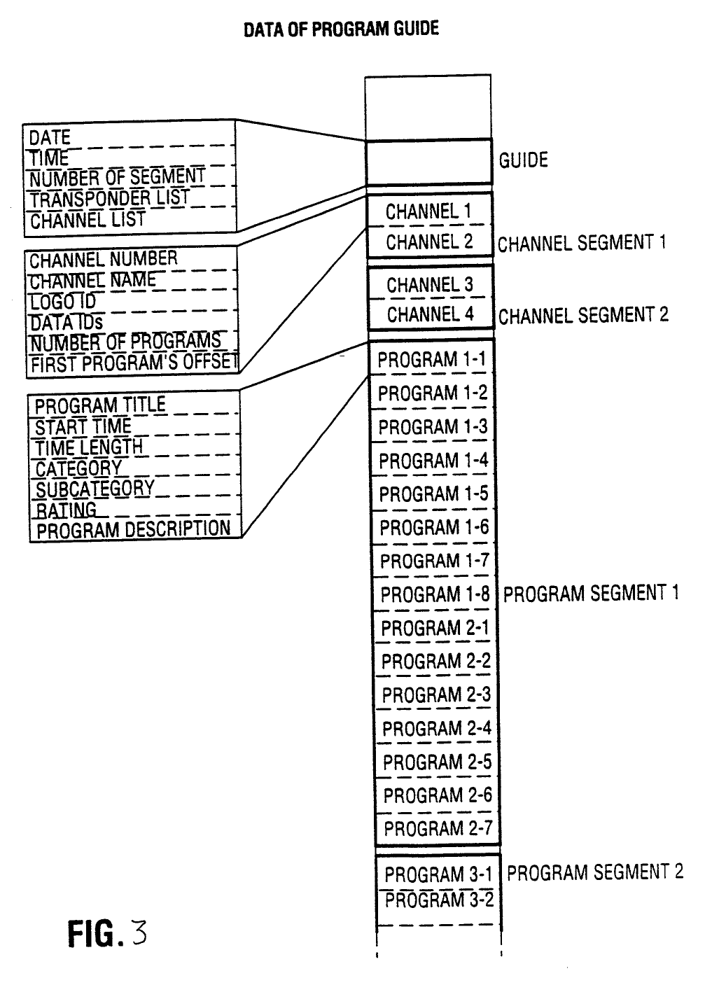

FIG. 3 is a block diagram illustration of the data stored in a portion of the data buffer RAM 51. As noted above, the RAM 51 stores EPG data including guide data, channel data, and program data. General information is included in the guide data, for example, the current date and time. The transponder list identifies the number of the transponder transmitting a segment. The channel list identifies the channel number of the first channel of a portion of data. The channel data includes data relating to channels, such as the channel number, channel name (i.e., the call sign of a broadcast station), logo ID (i.e., an identification of the channel logo), data ID, which is an identification of a channel number of MPEG video data or MPEG audio data, number of programs, which identifies the number of programs to be transmitted on a channel during a predetermined time frame, and first program offset which identifies the offset from the header to the first channel data in a segment.

The program data includes the program title, start time of the program, time length of the program, program category such as movies, news, sports, etc., program subcategory such as drama, horror, children's movies or baseball, basketball, football for the sports category, the movie rating and program description that provides a detailed description of the program.

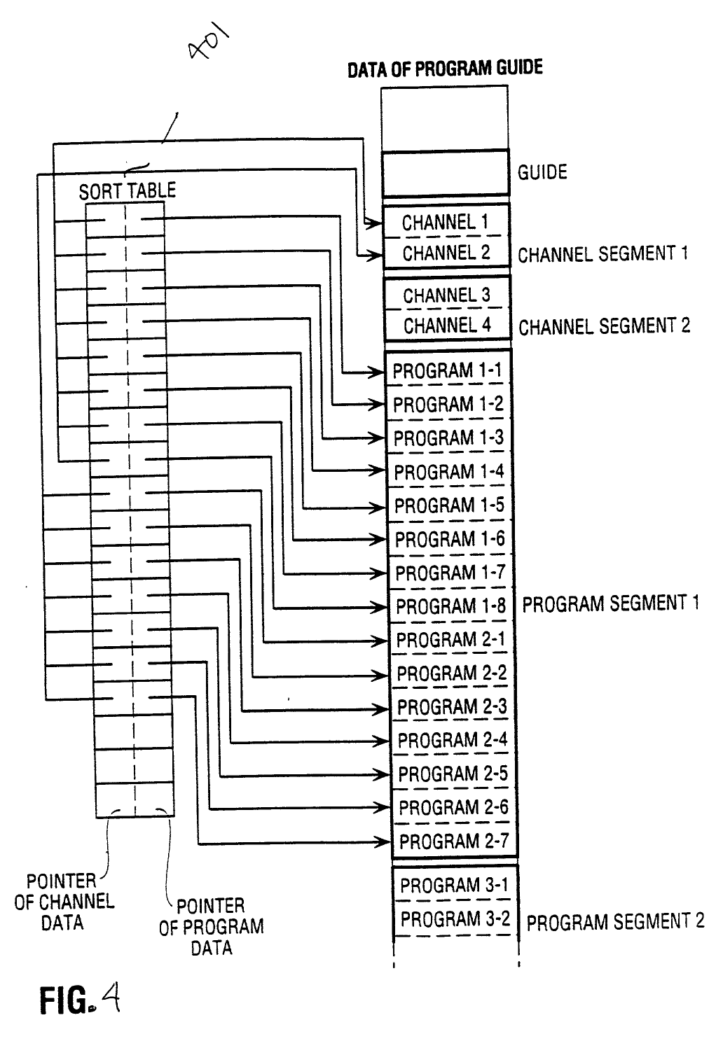

FIG. 4 illustrates how pointers to the EPG data are sorted for display on a guide on the user's television screen. As noted above, EPG data includes guide data, channel data and program data which are stored in the Data Buffer (RAM) of the IRD. When a viewer selects a channel, the CPU of the system determines the packet containing the channel information and extracts the transponder number from the channel information. The system front end starts tuning in the frequency of the designated transponder so as to receive the data transmitting from that transponder. If a viewer does not select any channel, the last channel is preferably designated.

As noted above, the CPU generates a table of pointers 401 to the EPG stored in the memory. The table 401 is used for changing the order of channels or programs according to the information to be presented in the guide to the user. The table 401 includes an entry for the address pointer to the corresponding channel data and an entry to the corresponding program data.

A table for generating display information is stored in the ROM 37. Certain data from the table is read out from the ROM 37 and stored in DRAM 25a. Preferably the data is stored in compressed form. Therefore, when a character is displayed on a screen, the compressed character array is decoded so as to generate the character to be displayed. The encoder references a dictionary, which includes a set of words and frequently used portions or words and numbers corresponding to each word or portion of a word. The encoder encodes each word to each number by using the dictionary. The decoder references the same dictionary as the encoder to perform the decode function. Once decoded, each character of the decoded word includes a character code corresponding to an American Standard Code for Information Interchange (ASCII) code. Nonvolatile memory (e.g., EEPROM 38) has two tables. The first table contains character bitmaps in the different fonts available for each character. The second table identifies the address in the first table at which to extract the character bitmap. The address is determined according to the character code. The bit map image of the character is transmitted to DRAM 25a and subsequently accessed to display the character on the screen.

In one embodiment of the present invention, the channel data is received from a predetermined transponder and the channel number and channel name are stored in DRAM 25a. Additional channel information, such as the channel logo is stored in the ROM 36. The ROM 36 preferably includes a table of Logo IDs and the address of Logo Data stored in ROM 36. Therefore, once a Logo ID is determined, the address of the Logo Data is determined, retrieved and stored in DRAM 25a.

The channel data provides the beginning address of the program data for a particular program. The actual location on the screen at which the program information is displayed is dependent upon the format of the guide. For example, in a time-based system, the location where the program title is displayed is determined by the start time and time length stored in the program data.

Using this information downloaded from the satellite transmission, programming and channel selection information is provided to the viewer. In the system and method of one embodiment of the present invention, this information is provided to the user in an innovative manner in order to enable the viewer to easily determine and select stations or programs to be viewed.

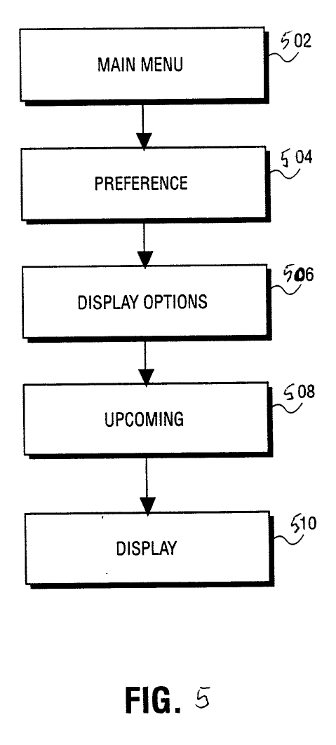

FIG. 5 is one embodiment of a process for generating an upcoming program information display, which may be used in accordance with one embodiment of the present invention. The operations in FIG. 5 may further describe operations that may be taken for generating an upcoming program information display. At operation 502, a main menu may be provided on display for selection. Several methods may be used to select the main menu. For example the selection may be made by a user, service provider, network, or be preprogrammed selection. The main menu may contain several preference menus one of which may be a selectable preference menu containing display options. The main menu may be configured to allow a selection to be made for a preference menu, and a selection of the preference menu may be made in operation 504.

In operation 506, selection of the Preference menu on the Main Menu display may generate a preference menu to be displayed. In operation 506, the generated preference menu may contain a number of display options. The visual display design of the preference menu and its options may be designed in several styles as desired. In one embodiment, the preference menu may have a preference option such as “Display Options”.

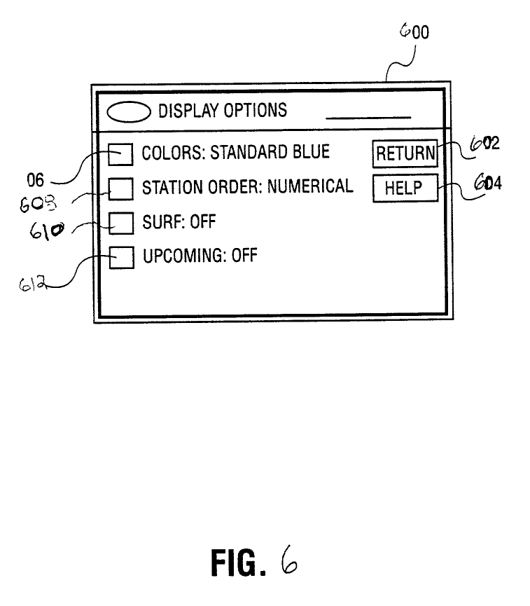

The selection of “Display Options” in operation 506 may generate a display options menu 600 on display, as in operation 510. One embodiment of the display options menu is shown in FIG. 6. The display options menu 600 may contain several selectable display options. In one embodiment, the selectable display options within the display options menu 600 may be a return feature option 602, a help feature option 604, a colors selection option containing an wide variety of colors 606, a station order option 608, a surf ON/OFF option 610, and an upcoming program option 612. The display options as described in FIG. 6 may be created and deleted by a user, service provider, network etc. The creation and deletion options may also be restricted to a particular user, service provider, network etc. such that a password or other some other recognition may be required for entering and creating or deleting display options.

The display options menu 600 may allow a selection of either proceeding forward by selecting any of display options, or to return back to the preference menu by selecting return, or to provide help features by selecting help feature. For example, selecting the return feature 602, may take the user back to the preference menu and allow a preference menu to be displayed as in operation 504. Alternately, the help feature 604 may be made by selected. This selection may provide further help features in a menu that is displayed. The menus may contain several categories of help and be configured to allow a user to navigate to an area of help desired. The help feature may also contain a return feature that may be selected to return back to the display options menu 600 as described above.

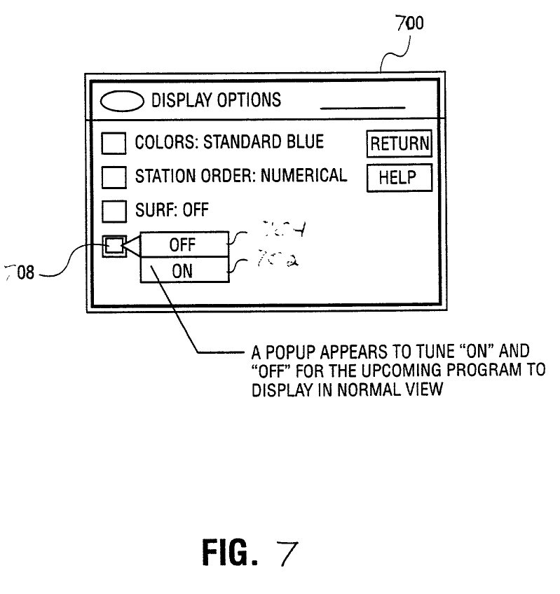

The upcoming program option 612 may be selected as shown in operation 508. As shown in FIG. 7, this selection may provide a further selection of an ON option 702 and an OFF option 704. The visual display design of the ON/OFF option 612 may vary and be designed in several styles as desired.

Selecting the ON option may generate a program information display for an upcoming program to be displayed on the display. The selection may be indicated by highlighting, flashing, and changing color etc.

In one embodiment, a user may select the desired upcoming ON/OFF option 612, and in another embodiment, the selections may be made by a preprogrammed system, service provider, network, or otherwise partially or fully automated.

In one exemplary embodiment the programming schedules of the EPG may be accessed on a limited basis while viewing a currently selected program.

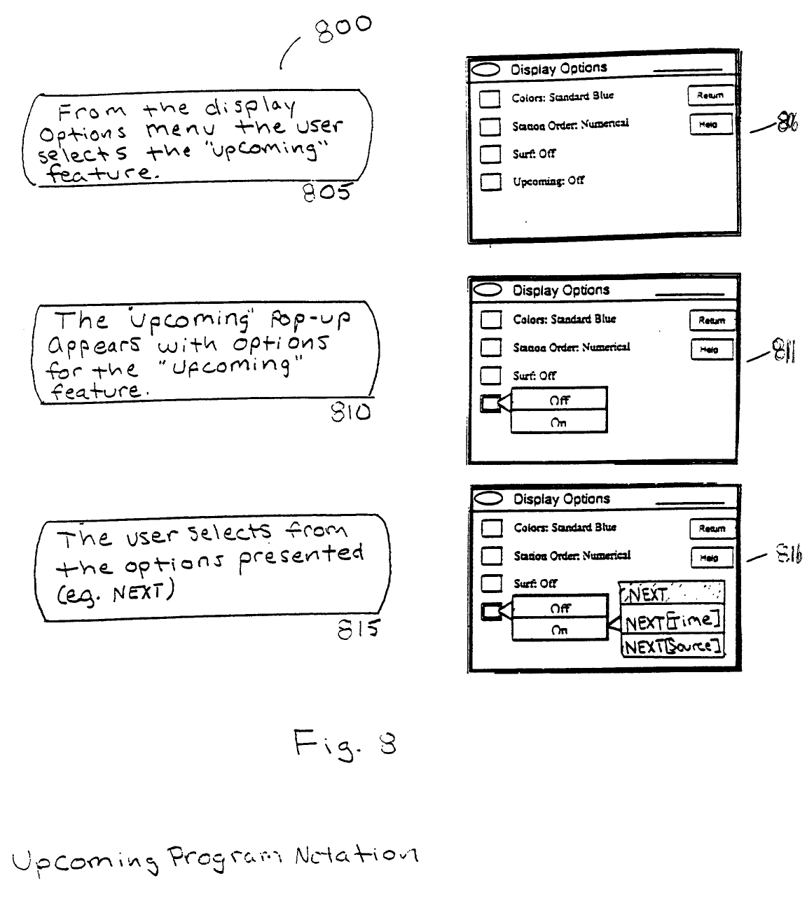

FIG. 8 is a flow diagram illustrating a process of one embodiment of the upcoming program information display process. The process 800 shown in FIG. 8 begins at operation 805, in which the user selects the Upcoming program information feature from the display options screen 806. In operation 810, the Upcoming program information feature pop-up appears as shown in the display options screen 811. The user selects from the options presented in the Upcoming program information feature in operation 815. For example, if the user wishes to know what program is scheduled next from the currently viewed source, the user selects NEXT as shown in display option screen 816. In other embodiments the user may wish to access other information from the EPG such as what programs are scheduled next for a given period of time or what program is scheduled next from a source other than the source of the program currently being displayed. If the user wishes to know what programs are scheduled next for a given period of time, the use selects NEXT [Time] and then selects a period of time. The user may wish to know what program is scheduled next from a different source (e.g. different station or a custom-made program schedule), if so the user selects NEXT [Source] and then selects a source. The Upcoming program information feature can display any information about an upcoming program contained in the EPG including title, category, start and stop time. This information regarding an upcoming program will be displayed for a selected time at selected intervals during the currently viewed program. The desired amount of time and time intervals may be preprogrammed by a user, service provider, Network etc. Other selections could be provided that would function similarly in allowing the user access to a select portion of the EPG programming information.

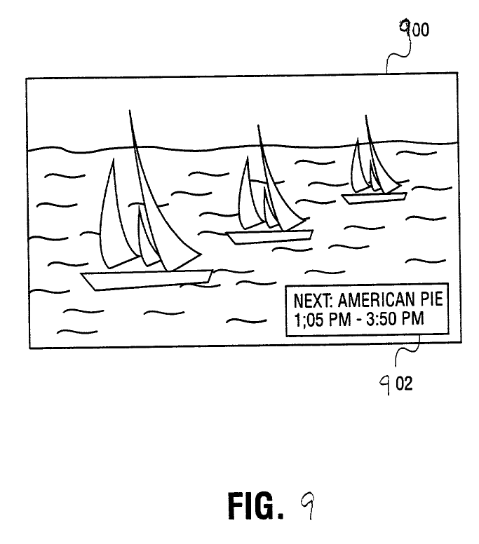

FIG. 9 depicts a display program 900 with the Upcoming program information selected and displayed. In one embodiment, the upcoming program information display 902 may be displayed in normal view. The upcoming program information display 902 may contain information such as a title of the next upcoming program, a start and an end time of the upcoming program and other information related to the showing of the upcoming program. For example the title may read “American Pie” for the next up coming program and the start time may read “1:05 PM” and the end time may read “3:50 PM” as shown in FIG. 9.

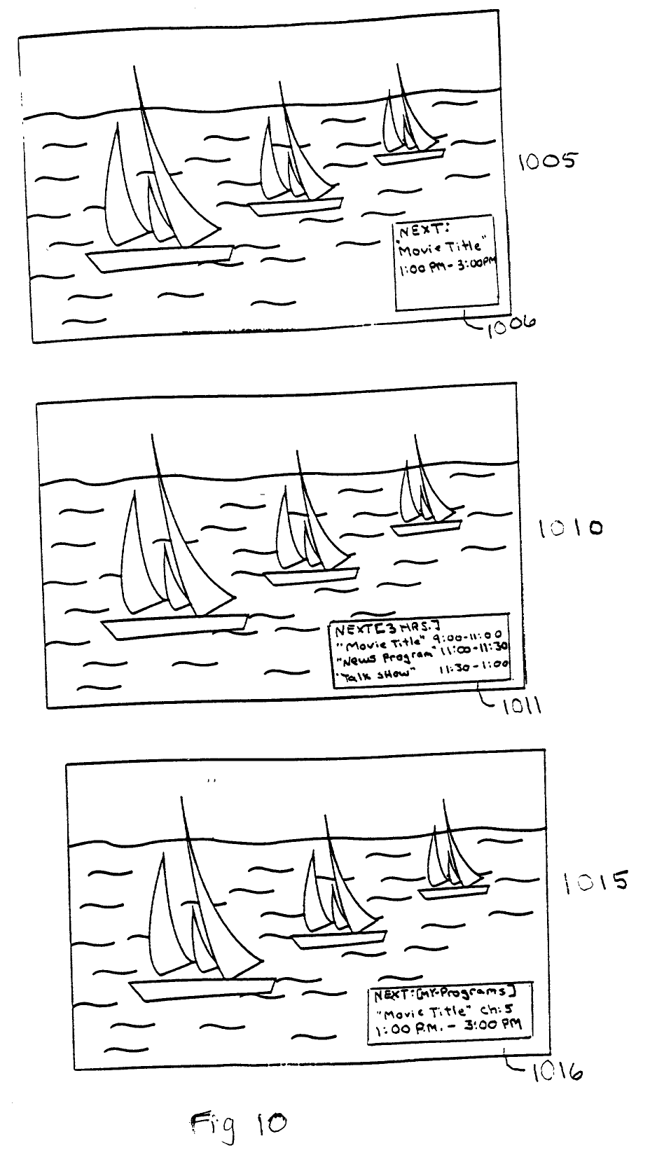

FIG. 10 depicts display examples 1005, 1010, and 1015 of information which will be displayed along with the currently viewed program when the Upcoming program information feature has been selected. In the display of 1005, the user has selected the NEXT option and the next program scheduled, from the currently viewed source, is noted in Upcoming program information display 1006. In 1010, the user has selected the NEXT [Time] option and has input three hours as the period of time. Programs scheduled for the next three hours are noted in Upcoming program information feature display 1011. In 1015, the user has selected the NEXT [Source] option and input a custom-made program schedule as the source. The next program of that custom-made program schedule is noted in Upcoming program information feature display 1016.

In the foregoing detailed description, the methods and apparatuses of the present invention have been described with reference to specific exemplary embodiments. It should be understood that the methods and apparatuses of the invention can be practiced with modification and alteration within the spirit and scope of the appended claims. The description is thus to be regarded as illustrative instead of limiting on the invention.

What is claimed is:

1. A method for displaying upcoming program information on a monitor display screen comprising:
providing, on a display options menu, a plurality of upcoming program information display options, at least one of the upcoming program information display options being selected by a user;
receiving the selected upcoming program information display options to specify the upcoming program information to be displayed; and
displaying the upcoming program information specified by the selected display option on the monitor display screen.

2. The method of claim 1, wherein the display options menu has a return feature, allowing user to navigate back to preference menu, the return feature being able to be selected by a user.

3. The method of claim 1, wherein the display options menu has a help feature, allowing user to navigate to several dependent help categories, the help feature being able to be selected by a user.

4. The method of claim 1, wherein the selected upcoming program information display options are indicated by highlighting.

5. The method of claim 1, wherein the display options menu is displayed in a popup window on the monitor display screen.

6. The method of claim 1, wherein displaying the upcoming program information includes presenting a title on display, the title corresponding to an upcoming program to be shown on the same channel.

7. The method of claim 6, wherein displaying the selected upcoming program information further includes presenting a starting and ending time of the upcoming program.

8. The method of claim 1, wherein the selected upcoming program information display options are selected from the group consisting of a source option such that the user can specify a source for which the upcoming program information is desired and a time option such that the user can specify a time period for which the upcoming program information is desired.

9. The method of claim 1, wherein the upcoming program information is displayed for a specified amount of time, the amount of time being preprogrammed by a user, such that the upcoming program information is no longer displayed after expiration of the specified amount of time.

10. The method of claim 10, wherein specified amount of time is five seconds.

11. The method of claim 1, wherein the upcoming program information is displayed in a bottom right hand corner of the monitor display screen.

12. The method of claim 1, wherein the upcoming program information is displayed in a rectangular shaped box on the monitor display screen.

13. A machine-readable medium that provides instructions, which when executed by at least one processor, causes the at least one processor to perform a method comprising:
providing, on a display options menu, a plurality of upcoming program information display options, at least one of the upcoming program information display options being selected by a user;
receiving the selected upcoming program information display options to specify the upcoming program information to be displayed; and
displaying the upcoming program information specified by the selected display option on the monitor display screen.

14. The machine-readable medium of claim 14, wherein the display options menu has a return feature, allowing user to navigate back to preference menu, the return feature being able to be selected by a user.

15. The machine-readable medium of claim 14, wherein the display options menu has a help feature, allowing user to navigate to several dependent help categories, the help feature being able to be selected by a user.

16. The machine-readable medium of claim 14, wherein the selected upcoming program information display options are indicated by highlighting.

17. The machine-readable medium of claim 14, wherein the display options menu is displayed in a popup window on the monitor display screen.

18. The machine-readable medium of claim 14, wherein displaying the upcoming program information includes presenting a title on display, the title corresponding to an upcoming program to be shown on the same channel.

19. The machine-readable medium of claim 14, wherein displaying the selected upcoming program information display options upcoming program information further includes presenting a starting and ending time of the upcoming program.

20. The machine-readable medium of claim 14, wherein the selected upcoming program information display options are selected from the group consisting of a source option such that the user can specify a source for which the upcoming program information is desired and a time option such that the user can specify a time period for which the upcoming program information is desired.

21. The machine-readable medium of claim 14, wherein the upcoming program information is displayed for a specified amount of time, the amount of time being preprogrammed by a user, such that the upcoming program information is no longer displayed after expiration of the specified amount of time.

22. The machine-readable medium of claim 23, wherein specified amount of time is five seconds.

23. The machine-readable medium of claim 14, wherein the upcoming program information is displayed in a bottom right hand corner of the monitor display screen.

24. The machine-readable medium of claim 14, wherein the upcoming program information is displayed in a rectangular shaped box on the monitor display screen.

25. A system for displaying upcoming program information, the system comprising:
a display;
an input configured to receive user input; and
a processor coupled to the display and the input, said processor displaying a broadcast of a program, receiving upcoming program information, overlaying a display of at least one portion of the broadcast at least one portion of the upcoming program information.

26. The system of claim 25, wherein the at least one protion of the upcoming program information is displayed for a specified amount of time, the amount of time being preprogrammed by a user, such that the upcoming program information is no longer displayed after expiration of the specified amount of time.

27. The system of claim 25, wherein the at least one portion of the upcoming program information is selected from the group consisting of a source, such that the upcoming program information displayed is for a user- specified source, and a time, such that the upcoming program information displayed is for a user-specified time period.

28. The system of claim 25, wherein the at least one portion of the upcoming program information includes a starting and ending time of the upcoming program.

29. The system of claim 25, wherein the at least one portion of the upcoming program information includes a title, the title corresponding to an upcoming program to be shown on the same channel.

30. A method for displaying upcoming program information comprising:
displaying a broadcast of a program;
receive upcoming program information; and
displaying at least one portion of the upcoming program information over the displayed broadcast.

31. The method of claim 30, wherein the at least one protion of the upcoming program information is displayed for a specified amount of time, the amount of time being preprogrammed by a user, such that the upcoming program information is no longer displayed after expiration of the specified amount of time.

32. The method of claim 30, wherein the at least one portion of the upcoming program information is selected from the group consisting of a source, such that the upcoming program information displayed is for a user- specified source, and a time, such that the upcoming program information displayed is for a user-specified time period.

33. The method of claim 30, wherein the at least one portion of the upcoming program information includes a starting and ending time of the upcoming program.

34. The system of claim 30, wherein the at least one portion of the upcoming program information includes a title, the title corresponding to an upcoming program to be shown on the same channel.

35. A display for indicating upcoming program information comprising:
a first image comprising an upcoming program information display options menu, including a plurality of upcoming program information display options, at least one option being selected by a user; and
an input configured to receive user input; and
a second image comprising the upcoming program information determined by the selected at least one option.

36. The display of claim 35, wherein the upcoming program information determined by the selected at least one option includes a title, the title corresponding to an upcoming program to be shown on the same channel.

37. The display of claim 35, wherein the upcoming program information determined by the selected at least one option further includes presenting a starting and ending time of the upcoming program.

38. The display of claim 35, wherein the upcoming program information display options include a source option, such that the user can specify a source for which the upcoming program information is desired, and a time option, such that the user can specify a time period for which the upcoming program information is desired.

39. The display of claim 35, wherein the second image is displayed for a specified amount of time, the amount of time being preprogrammed by a user, such that the upcoming program information is no longer displayed after expiration of the specified amount of time.
